(19) United States
(12) Patent Application Publication
(10) Pub. No.: US 2009/0060387 A1
(43) Pub. Date: Mar. 5, 2009

(54) OPTIMIZATIONS FOR RADIUS OPTICAL BLUR

(75) Inventor: Douglas A. Ricard, Woodinville, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/849,368

(22) Filed: Sep. 4, 2007

(51) Int. Cl. G06K 9/36

(52) U.S. Cl. 382/298

(57) ABSTRACT

Optical blur architecture that provides a significant improvement in the computation processes required to create optical blur. The architecture can be applied to efficiently implement optical blur on an image where the radius may vary from pixel to pixel and when the radius does not vary at all. The solution includes a significant improvement in computational efficiency. A wide range of radiuses can be handled and any radius within that range without the need for an infinite number of masks or having to create masks on-the-fly. An infinite number of virtual radius tables can be generated from a small number of tables. A list of tables can be logarithmically generated and utilized for a wide range of radiuses the table sizes can be reduced by storing the weight information for the entire area of the mask and only storing the delta values from the previous radius.

### BACKGROUND

Blurring is an image processing technique used in image processing and texture generation. Optical blur is the more realistic blur created when an object is out of focus. In optical blur a point light source becomes a constant luminance disk. Because the conventional implementations are computationally more expensive than one technique known as Gaussian blur, Gaussian blur is often used instead. Certain characteristics of the Gaussian function mean that large blurs can be applied much faster than other kinds of blur filters.

The application of blur can involve the computation of averages. In other words, the average value of a set of pixels around (or in the neighborhood of) one pixel is computed and then applied to all pixels in the set. In another technique, computation is based on weighted averages where the weight applied to a central pixel is the highest weight, with the pixel weights decreasing as the radius increases from the central pixel. Moreover, multiple passes maybe required to achieve the desired result. Other conventional techniques for addressing Gaussian blur include separating passes into horizontal and vertical, reusing results, and using transpose functions to reduce the amount of code. However, Gaussian blur generates a gradient effect from the center of the blur to the edge, and not all techniques compatible with Gaussian blur can be employed for generating optical blur. In any case, the time to process such effects to generate the final optical blur result remains computationally expensive.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture provides a significant improvement in the computation processes required to create optical blur (optical blur is oftentimes referred to as out-of-focus blur). The architecture can be applied to efficiently implement optical blur on an image where the radius may vary from pixel to pixel and when the radius does not vary at all. Thus, optical blur effects can be provided very fast, using any radius, and in multiple areas of an image by different amounts.

The architecture employs a technique whereby the solution is proportional to the number of pixels rather than number of pixels times radius squared (e.g., from order k₁NR² (N is number of pixels, R is radius) to order k₂NR) in computational efficiency which, for a large 1000 pixel radius, for example, can reduce the computational operations from one million operations to a hundred operations without a major loss in blur quality.

The architecture provides the ability to handle a wide range of radiuses with the image and any radius within that range, without needing an infinite number of masks or having to create masks on the fly. This works on both software and a graphics processing unit (GPU).

One implementation of optical blur employs a pair of tables of pixel offsets and weights which represent the source pixels, with weights to be applied to the source pixels for use in generating the destination pixel for a pair of blur radius and simple interpolation for all radiuses between the two. A solution allows the generation of an infinite number of virtual radius tables from a small number of tables. This works on both software and the GPU.

Where there is a need for a large range of radiuses, a large number of tables may be desired to cover a wide range of radiuses. One exemplary implementation generates and uses a list of tables where the radiuses are based on an exponential function. The larger the radius, the less visible the difference between the interpolated and real table. This works on both the central processing unit (CPU) and the GPU.

Where tables are desired, these tables can also take up a lot of space in the sources. The architecture provides an optimization which allows the table sizes to be reduced by storing the weight information for the entire area of the mask and only storing the delta values from the previous radius.

In the case where there is only a single radius for the entire image, the architecture reduces a second order problem (e.g., R²) to a single order problem, thereby further reducing computational expense for the blur process.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a system for optical blur processing that includes one or more optimizations that reduce the computational cost.

FIG. 2 illustrates a process for generating infinite virtual radius tables for optical blur by interpolation.

FIG. 3 illustrates an optional system where the table generation can include an exponential component for generating a large number of tables to cover a wide range of radiuses when there no longer is a need for infinite tables.

FIG. 4 illustrates an exemplary embodiment for processing optical blur based on image downscaling.

FIG. 5 illustrates a technique for reducing table size by storing delta weight values relative to a previous radius table.

FIG. 6 illustrates an optional optimization using area cancellation in the case where there is only a single radius for the entire image.

FIG. 7 illustrates a method of providing optical blur in an image.

FIG. 8 illustrates a method of applying interpolation to generate a wide range of radius values.

FIG. 9 illustrates a method of generating optical radius tables using an exponential function.

FIG. 10 illustrates a method of using source image downscaling for optical blur of an image.

FIG. 11 illustrates a method of reducing table size based on inherited pixel information of a smaller radius table.

FIG. 12 illustrates a method of optimizing computational efficiency by reducing the number pixel areas for processing the optical blur on an output pixel.

FIG. 13 illustrates a block diagram of a computing system operable to execute optical blur in accordance with the disclosed architecture.

### DETAILED DESCRIPTION

The disclosed architecture discloses techniques for supporting significant improvements in generating optical blur. The improvements in computation are the result of handling radius tables. In exemplary embodiments, an infinite number of virtual tables can be generated from a small subset of tables, tables can be generated exponentially, and tables are created based on delta values of a previous table. Another embodiment describes the reduction of the source image in successive passes thereby maintaining the size of the optical blur radius. Yet another embodiment reduces the computational cost where only a single radius is used for the entire image.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

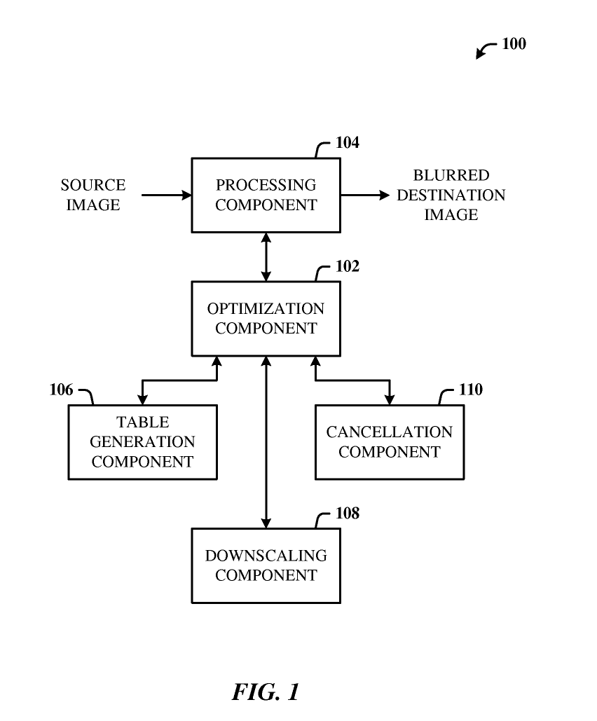

Referring initially to the drawings, FIG. 1 illustrates a system 100 for optical blur processing that includes one or more optimizations that reduce the computational cost. The system 100 comprises an optimization component 102 for generating data associated with an optical blur process and a processing component 104 for processing the data to apply optical blur to a destination image. The optimizations facilitated by the optimizations component 102 include table generation techniques (via a table generation component 106) that include generating an infinite number of virtual tables by interpolation, exponential radius computation, and by delta values. Optimizations also include downscaling the source image via a downscaling component 108, and by area cancellation using a cancellation component 110. Each of these will now be described with greater specificity.

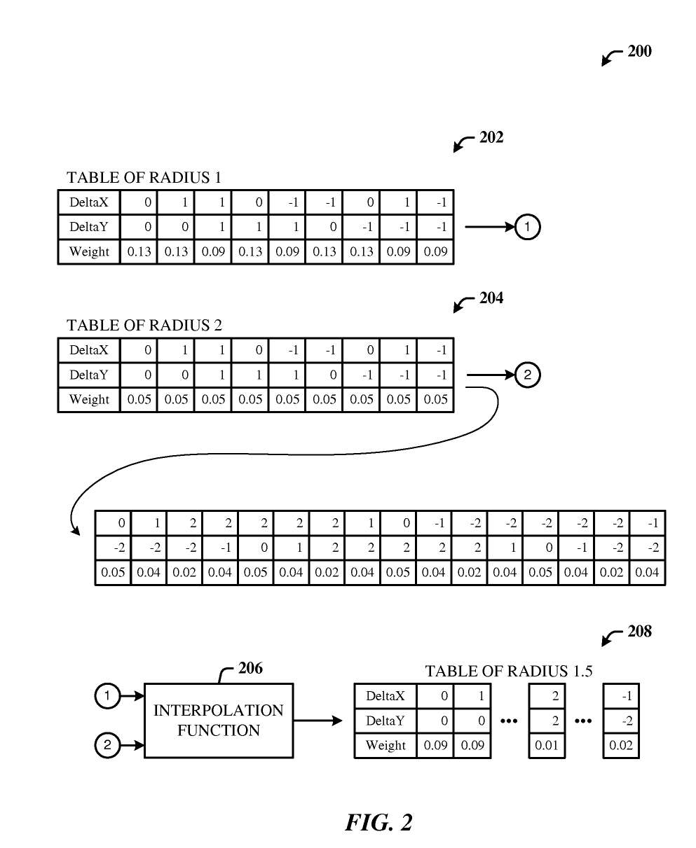

FIG. 2 illustrates a process 200 for generating infinite virtual radius tables for optical blur by interpolation. The process 200 begins with a source table of pixel offsets and weights which represent the source pixels, and weights to be applied to the source pixels for use in generating the destination pixel. For example, a radius 1 optical blur can have a source table 202 derived from the following interpolation function 206.

Destination Pixel(x,y)=Sum(for each tableEntry in the table) (pixelSource(x+tableEntry.deltaX,y+tableEntry.deltaY)*tableEntry.weight)

To allow a range of blur radiuses within the image, a different table for each radius is needed. In order to support non-integer (or real) number radiuses within a range, infinite tables can be provided. The process 200 generates infinite virtual radius tables from a small number of tables. This works in both software and GPU, but is more optimized for a GPU. Given the table 202 for radius 1 and a table 204 for a radius 2, linear interpolation can be applied to obtain a radius table 208 for 1.5.

By assuming (or by implementing constraints to this effect) the same column has the same X and Y coordinates, the radius table 208 (or mask) can be generated for any radius between the values of tables 202 and 204 by linearly interpolating the weight values between the two tables (202 and 204). For example, if a mask for a radius of 1.5 is desired, (0,0)'s weight is (0.13+0.05)/2, (2,2)'s weight is (0+0.02)/2, and so on. This solution creates at most a ring of fuzziness which is the difference between the table radiuses. This allows optical blur without forcing the generation of an infinite number of tables.

In the GPU, this uses linear, rather than point filtering and putting this table in a texture, one table entry per pixel (DeltaX→Red, DeltaY→Green, Weight→Blue), one row per “radius table”. Thus, if sampling an entry between two radiuses (rows), the linear interpolated values are obtained. The same process can be done in software, but with tables and code to perform the interpolation.

An alternative embodiment to this involves the packing of data such that larger radiuses can use smaller radiuses tables and then add additional entries to the smaller table.

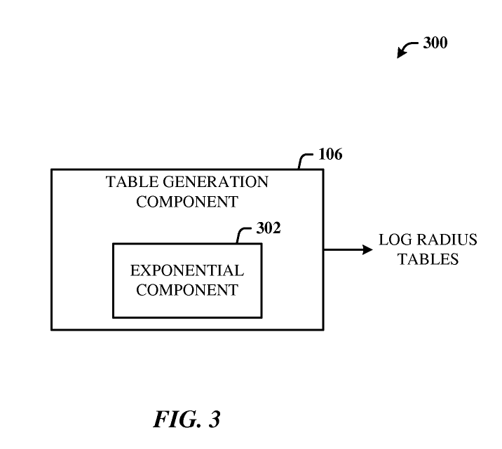

FIG. 3 illustrates an optional system 300 where the table generation component 106 of system 100 can include an exponential component 302 for generating a large number of tables to cover a wide range of radiuses when there no longer is a need for infinite tables. For example, log-type optical blur radius tables can be generated for radius values of 0.5, 1, 1.6, 2.4, 3.5, 5, 7, 10, 14, 19, etc. The larger the radius value, the less visible the difference between the interpolated and real table. This exponential generation works in both the GPU and the CPU.

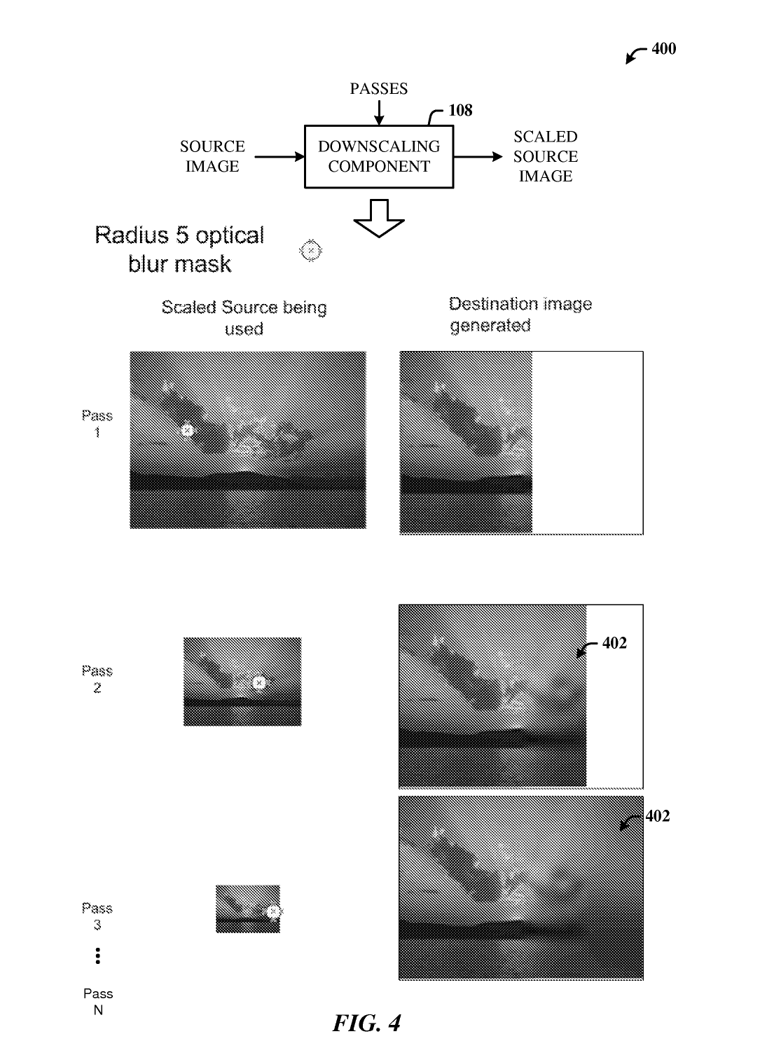

FIG. 4 illustrates an exemplary embodiment for processing optical blur based on image downscaling. The previous embodiments decreased the number of tables needed to be generated, but still required πR² source pixels to be read to generate a destination pixel. For large R, that is unaffordable. By allowing some loss in edge sharpness, performance can be significantly improved.

For an optical blur with a constant radius for the entire image, this can be achieved by downscaling the image to a fraction of the blur radius. For example, if the desired blur radius was 100, the source image can be downscaled using a high-quality interpolation to 1/20 in each dimension. Then the blurred image can be generated by applying a 5-pixel optical blur on the downsampled source to generate each destination pixel.

For a non-constant radius optical blur, the downscaling component 108 of FIG. 1 performs log₂(R) passes through the image with each pass generating the blurred pixels for the set of pixels for whom the blur radius to be applied lies within the given range for that pass. However, the source image used on each successive pass is downscaled (e.g., to one-half size) from the previous pass. Thus, smaller radiuses can be run.

For example, for the first pass, blurred pixels are generated for radius 0-5 blur; for the second pass, radiuses 5-10; the third pass, radiuses 10-20; and so on. On each pass, the source image of the previous blur pass is used to do a high-quality scaling down (e.g., by a power of two). This allows the application of a radius ½ that which would otherwise need to apply to cover the same number of source pixels in the previous pass. Accordingly, on the second pass, the original radius 5 means applying radius 2.5 instead, radius 10 means actually radius 5. For pass three, applying a radius of 15 means actually applying a radius of 15/4 (scaled down twice, when using a factor of 2). Thus, an optical blur of more than 5 never needs to be applied to any source image no matter what actual radius is needed. This essentially imposes an upper bound on the radius value. In other words, the downscaling factor can be adjusted to maintain an upper limit on the radius value. Moreover, the downscaling is a very fast operation, even when using bi-cubic interpolation.

FIG. 4 illustrates how an output image can be generated if a radius of 5, 10 and 15 for the first, second, and third section of the image is desired. In each case, a radius of 5 is used, but the source pixels over which the convolution mask is run are changed (e.g., successively scale by factor of 2× for each dimension). The resulting blur is denoted at 402. The GPU can efficiently perform the downsampling automatically. Alternatively, a client can write their own sampling code for the GPU. The downsampling can be done in the CPU, as well.

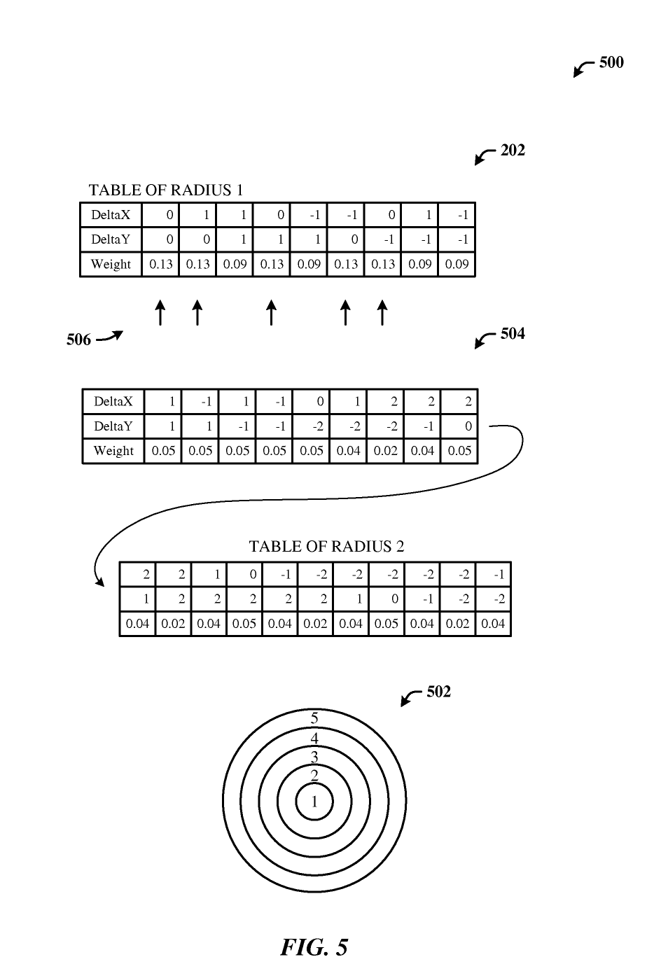

FIG. 5 illustrates a technique for reducing table size by storing delta weight values relative to a previous radius table. The tables (202 and 204) described in FIG. 2 still can require a significant amount of time to generate on demand. Thus, this makes those tables (202 and 204) good candidates for pre-computing and inserting into code. However, the tables (202 and 204) can also require a large amount of space in the sources. An optimization which allows the table sizes to be much smaller includes storing the delta of the weight values from the previous radius rather than storing the weight information for the entire area of the mask. This is represented pictorially at 502.

For example, the previous table 204 of FIG. 2 for radius 2 contains 25 entries. This new optimization replaces table 204 with a new table 504 (a difference table) that only contains 20 entries—the extra 5 entries (denoted by 506) can be inherited from the previous table 202. While the savings can be considered small for small radiuses, the ratio of the size of the difference (or delta) table 504 versus the size of the entire table 204 of FIG. 2 is approximately proportional to 1/R (the difference table size is proportional to the radius of the blur convolution mask, while the entire table is proportional to the area of the blur convolution mask). Using such an optimization, the information in the tables is then changed to make it radius-independent.

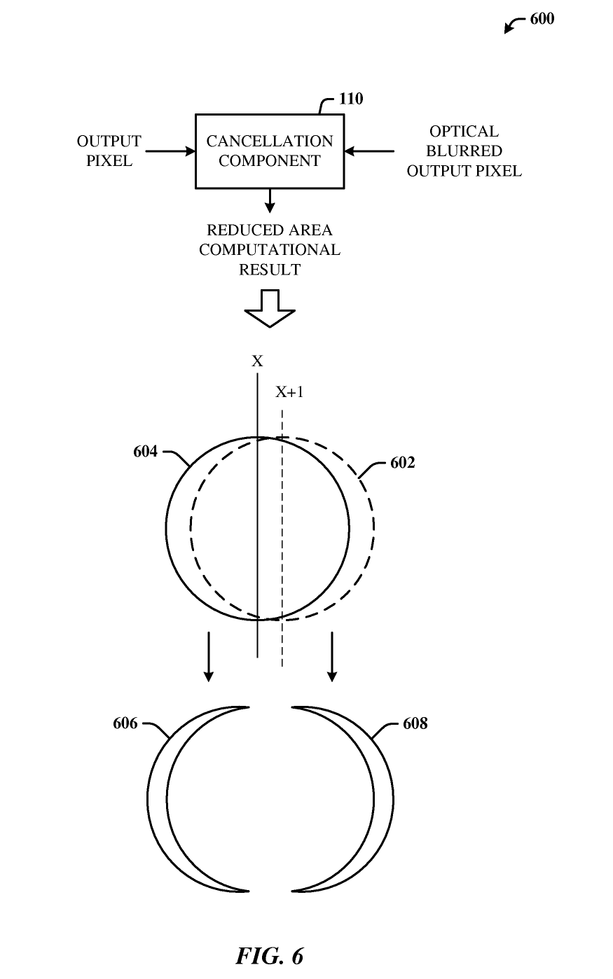

FIG. 6 illustrates an optional optimization using area cancellation in the case where there is only a single radius for the entire image. In this case, the order R² problem can be reduced to an order N problem. The optical blurred output pixel (X+1,Y) 602 is a function of the following: the generated output pixel (X,Y) 604, the pixels which were used to generate output pixel (X,Y) but not (X+1,Y) (the crescent 606), and the pixels used to generate (X+1,Y) but not (X,Y) (the crescent 608). In other words, P(X,Y)=Sum (pixel values in 604) divided by the number of pixels in the circle 604. P(X+1,Y) can be calculated as (the [previous sum]−[pixels values in left crescent 606]+[pixel values in right crescent 608]) divided by the number of pixels in circle 602. The [previous sum] has already been calculated. The number of pixels in the crescents (606 and 608) is far less than the area of circles, so the computational cost is far less to calculate.

Following are a series of flow charts in support of methods for efficient computation in an optical blur architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

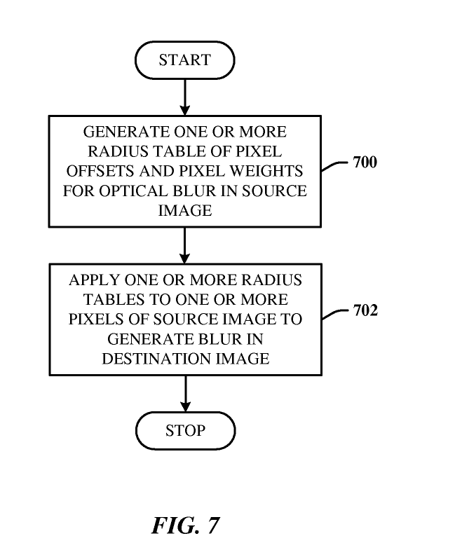

FIG. 7 illustrates a method of providing optical blur in an image. At 700, one or more radius tables of pixel offset values and pixel weight values are generated for creating optical blur in a source image. At 702, the one or more radius tables are applied to the source to generate blur in a destination image.

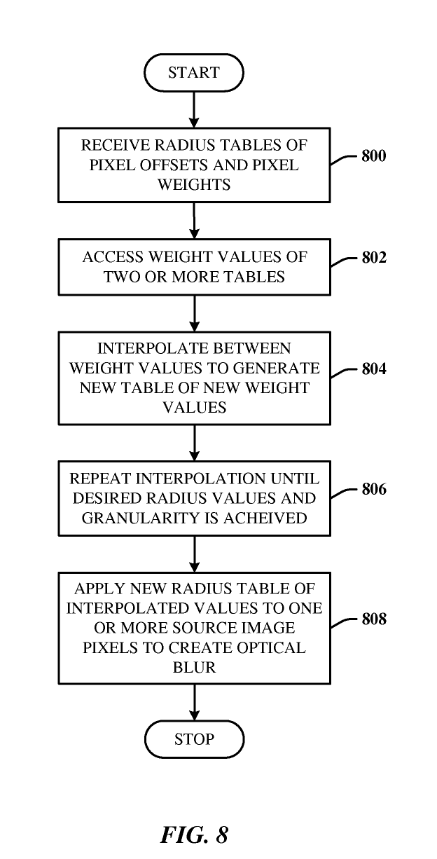

FIG. 8 illustrates a method of applying interpolation to generate a wide range of radius values. At 800, radius tables of pixel offsets and pixel weights are received. At 802, the weight values of two or more tables are accessed. At 804, interpolation is applied using two or more of the tables to generate a new table (a virtual table) of new weight values. At 806, the interpolation process is repeated until the desired radius values and granularity in the radiuses is achieved. At 808, the new radius table of interpolated values is applied to one or more source image pixels to create optical blur.

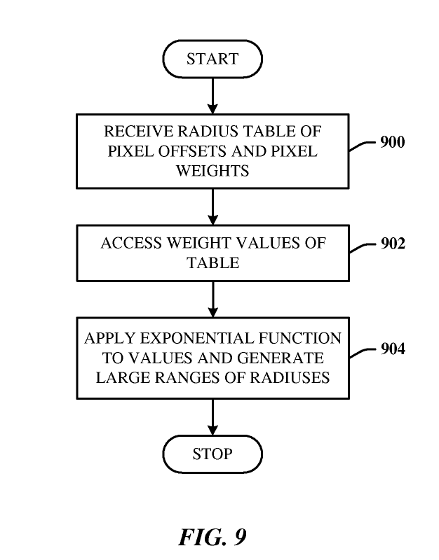

FIG. 9 illustrates a method of generating optical radius tables using an exponential function. At 900, a radius table of pixel offsets and pixel weights is received. At 902, the weight values are accessed. At 904, an exponential function is applied to the weight values to generate multiple tables that cover a large range of radiuses (both real and integer).

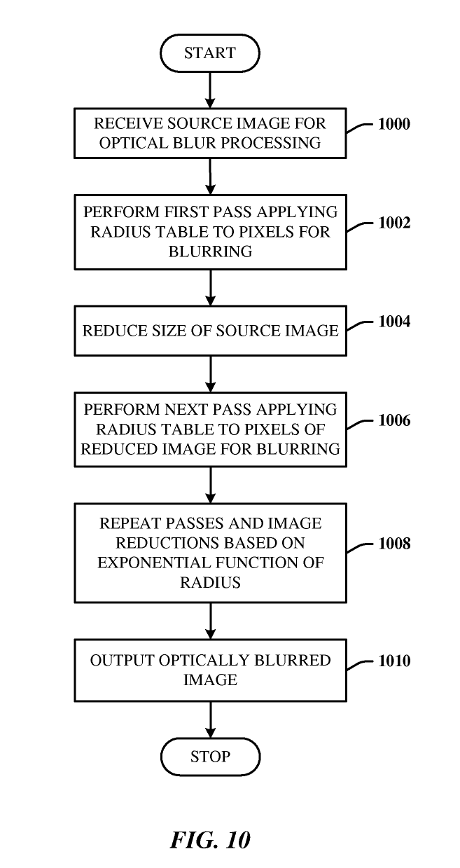

FIG. 10 illustrates a method of using source image downscaling for optical blur of an image. At 1000, a source image is received for optical blur processing. At 1002, a first pass is performed over the source image by applying a radius table to pixels. At 1004, the size of the source image is then reduced in preparation for the next pass. At 1006, the next pass is performed on the pixels of the reduced image. At 1008, the number of passes that reduce the image size and apply the tables continues based on an exponential function of the radius. At 1010, the process ends and the blurred image is output.

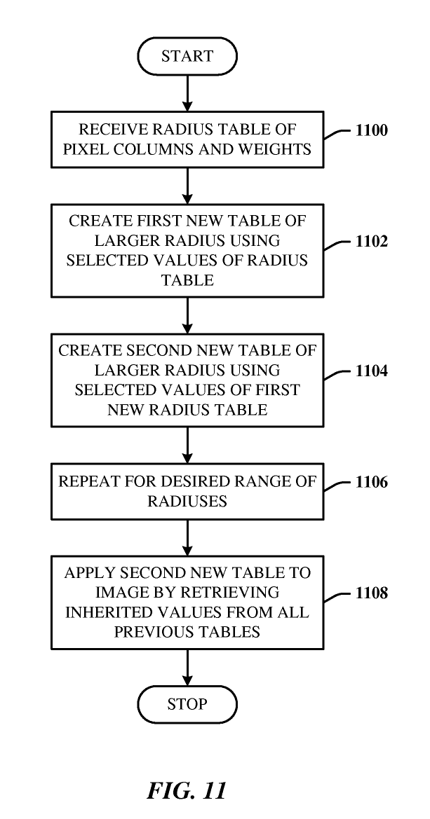

FIG. 11 illustrates a method of reducing table size based on inherited pixel information of a smaller radius table. At 1100, a radius table of pixel columns and weights is received. At 1102, a first new table of larger radius is created using selected values from the radius table. At 1104, a second new table of a larger radius is created using values of the first new radius table. At 1106, this process is repeated for the desired range of radiuses. At 1108, the second new table is applied to the image retrieving values inherited (or selected) from the previous tables.

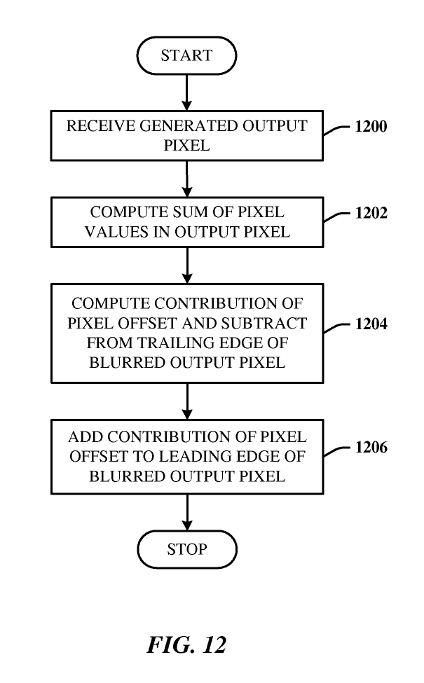

FIG. 12 illustrates a method of optimizing computational efficiency by reducing the number pixel areas for processing the optical blur on an output pixel. At 1200, the output pixel is received. At 1202, compute sum of pixel values in output pixel. At 1204, compute contribution of pixel offset and subtract from trailing edge of blurred output pixel. At 1206, add contribution of pixel offset to leading edge of blurred output pixel. In other words, there is significantly less processor time (CPU or GPU) required to compute the area in one crescent than the areas of the pixels. This involves computing pixel values outside the overlapping pixel area defined by an optical blurred output pixel and the generated output pixel. The process can be utilized when applying a single radius to the source image and a non-approximated optical blur is required.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

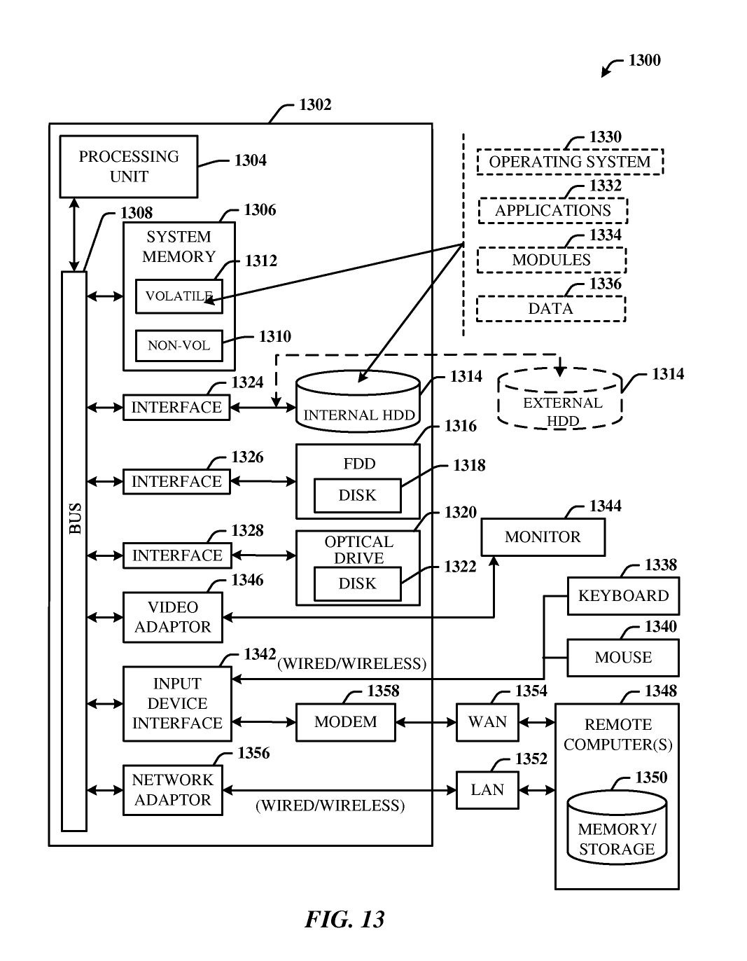

Referring now to FIG. 13, there is illustrated a block diagram of a computing system 1300 operable to execute optical blur in accordance with the disclosed architecture. In order to provide additional context for various aspects thereof, FIG. 13 and the following discussion are intended to provide a brief, general description of a suitable computing system 1300 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 13, the exemplary computing system 1300 for implementing various aspects includes a computer 1302, the computer 1302 including a processing unit 1304, a system memory 1306 and a system bus 1308. The system bus 1308 provides an interface for system components including, but not limited to, the system memory 1306 to the processing unit 1304. The processing unit 1304 can be any of various commercially available processors. Dual microprocessors and other multi-processor architectures may also be employed as the processing unit 1304. The processing unit 1304 can process the disclosed optical blur algorithms (embodied as components 102, 104, 106, 108, 110 and 302) individually or in combination with a GPU of the video adapter 1346.

The system bus 1308 can be any of several types of bus structure that may further interconnect to a memory bus (with or without a memory controller), a peripheral bus, and a local bus using any of a variety of commercially available bus architectures. The system memory 1306 can include non-volatile memory (NON-VOL) 1310 and/or volatile memory 1312 (e.g., random access memory (RAM)). A basic input/output system (BIOS) can be stored in the non-volatile memory 1310 (e.g., ROM, EPROM, EEPROM, etc.), which BIOS include the basic routines that help to transfer information between elements within the computer 1302, such as during start-up. The volatile memory 1312 can also include a high-speed RAM such as static RAM for caching data.

The computer 1302 further includes an internal hard disk drive (HDD) 1314 (e.g., EIDE, SATA), which internal HDD 1314 may also be configured for external use in a suitable chassis, a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as a DVD). The HDD 1314, FDD 1316 and optical disk drive 1320 can be connected to the system bus 1308 by a HDD interface 1324, an FDD interface 1326 and an optical drive interface 1328, respectively. The HDD interface 1324 for external drive implementations can include at least one or both of Universal Serial Bus (USB) and IEEE 1394 interface technologies.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 1312, including an operating system 1330, one or more application programs 1332, other program modules 1334 and program data 1336. The operating system 1330, one or more application programs 1332, other program modules 1334 and/or program data 1336 can include the components 102, 104, 106, 108, 110 of FIG. 1, and component 302 of FIG. 3, for example.

All or portions of the operating system, applications, modules, and/or data can also be cached in the RAM 1312. It is to be appreciated that the disclosed architecture can be implemented with various commercially available operating systems or combinations of operating systems.

A user can enter commands and information into the computer 1302 through one or more wire/wireless input devices, for example, a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device is also connected to the system bus 1308 via an interface, such as a video adapter 1346. A GPU of the video adapter 1346 can process the disclosed optical blur algorithms (embodied as components 102, 104, 106, 108, 110 and 302) individually or in combination with the processing unit 1304.

In addition to the monitor 1344, a computer typically includes other peripheral output devices (not shown), such as speakers, printers, etc.

The computer 1302 may operate in a networked environment using logical connections via wire and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wire/wireless connectivity to a local area network (LAN) 1352 and/or larger networks, for example, a wide area network (WAN) 1354. Such LAN and WAN networking environments are commonplace in offices and companies, and facilitate enterprise-wide computer networks, such as intranets, all of which may connect to a global communications network, for example, the Internet.

When used in a LAN networking environment, the computer 1302 is connected to the local network 1352 through a wire and/or wireless communication network interface or adapter 1356. The adaptor 1356 may facilitate wire or wireless communication to the LAN 1352, which may also include a wireless access point disposed thereon for communicating with the wireless adaptor 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wire and/or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An optical blur system, comprising:
a table generation component for operating in a mode that generates blur data in the form of an infinite number of radius tables by interpolation; and
a blur component for processing the blur data to impose optical blur on an image.

2. The system of claim 1, wherein the radius tables include real number radiuses that use interpolated weight values.

3. The system of claim 1, wherein the table generation component operates in a different mode that generates the blur data in the form of radius tables that are derived exponentially.

4. The system of claim 1, wherein the table component operates in a different mode that generates the blur data in the form of a radius table that includes weight values derived relative to another radius table.

5. The system of claim 1, wherein the table component operates in a different mode that generates a table having radius data that is radius independent.

6. The system of claim 1, wherein the table generation component and the blur component execute on at least one of a central processing unit (CPU) or a graphics processing unit (GPU).

7. The system of claim 1, wherein the table generation component generates new blur data that automatically inherits values from the blur data when the new blur data is applied when imposing the optical blur.

8. An optical blur system, comprising:
a downscaling component for reducing a source image in scale for each of one or more passes through the source image based on a predetermined downscaling factor; and
a blur component for imposing optical blur on the source image with a successive pass.

9. The system of claim 8, wherein a number for the one or more passes is derived logarithmically.

10. The system of claim 8, wherein the optical blur is imposed on a subset of pixels of the source image that lies within a non-constant blur radius value which decreases proportionally to the downscaling factor.

11. The system of claim 8, wherein the downscaling component reduces the image in scale according to a fraction of a blur radius in each dimension.

12. A computer-implemented method of providing optical blur to an image, comprising:
receiving a source image on which to impose optical blur;
operating in a mode that generates pixel offsets and pixel weights in the form of an infinite number of radius tables by interpolation; and
processing the radius tables to impose optical blur on the source image.

13. The method of claim 12, wherein the interpolation is linear.

14. The method of claim 12, further comprising generating a new set of virtual radius tables based on the pixel offsets and pixel weights.

15. The method of claim 14, wherein the new set is generated using an exponential function to output real number and integer blur radiuses.

16. The method of claim 12, further comprising reducing size of the source image successively based on a corresponding logarithmic number of passes over the source image in accordance with an applied blur radius value.

17. The method of claim 12, further comprising reducing size of a radius table of a new set of pixel offsets and pixel weights for optimized storage by storing delta weight values computed from one of the radius tables.

18. The method of claim 17, wherein values stored in the table are radius independent.

19. The method of claim 17, wherein the size of the radius table is proportional to a radius of a blur convolution mask.

20. The method of claim 12, further comprising computing pixel values outside an overlapping pixel area defined by an optical blurred output pixel and a generated output pixel when applying a single radius to the source image.
